(19) United States
(12) Patent Application Publication
(10) Pub. No.: US 2004/0070518 A1
(43) Pub. Date: Apr. 15, 2004

(54) Emergency vehicular traffic signal control

(76) Inventors: Carroll Whittle JR., San Clemente, CA (US); Mostafa Katebian, Laguna Niguel, CA (US); Kenneth L. Mitchell, Kirtland, OH (US)

Correspondence Address: Kenneth L. Mitchell, 9213 Chillicothe Road, Kirtland, OH, 44094, US

(21) Appl. No.: 10/264,627

(22) Filed: Oct. 4, 2002

(51) Int. Cl. G08G 1/095

(52) U.S. Cl. 340/907; 340/693.1

(57) ABSTRACT

An emergency vehicular traffic control apparatus is disclosed and claimed. A process for supplying emergency power to a traffic signal is disclosed and claimed. Emergency energy may be stored in a deep cycle battery, compressed air energy storage, or hydrogen tank (fuel). The energy source may be mounted adjacent existing control stations or it may be mounted inside the large metal poles typically used to support traffic signals.

### FIELD OF THE INVENTION

The invention is in the field of emergency traffic signal control.

### BACKGROUND OF THE INVENTION

California has been hard hit with a recent electrical energy crisis. Simply put, the energy crisis is real. Nearly 30 years ago the government warned that the United States of America was running short of power in the form of hydrocarbons. Energy production, particularly electrical energy, has been greatly curtailed due to environmentalism. California is particularly a victim of such environmental extremism. Everyone believes in a healthy environment and a secure future for the inhabitants of the United States of America to come after them. Nonetheless, adequate electrical power supply is necessary to enjoy a safe and prosperous future.

California has faced rolling blackouts. The blackouts are indiscriminate and cause a cessation of power to controllers which control traffic signals. Motorists without traffic signals simply don't know what to do. Many motorists don't stop as they should when a signal is not functioning. This has caused loss of life and limb in California in numerous accidents. The problem (lack of reliable utility generated power) is not expected to get any better in the near future. In addition to a lack of power due to a lack of electrical generating capacity, power may be lost through natural catastrophes such as wind, hurricanes, tornadoes, and the like.

Therefore, there is a need to control vehicular traffic at intersections everywhere upon the loss of electrical power from the utility. An interesting article entitled “Physical Limits of Portable Power Storage” by Michael Patrick Johnson can be found at http://aries.www.media.mit.edu/people/aries/portable-power/power.html. Mr. Johnson's article discusses portable power storage in the form of flywheels, compressed air tanks, ultra capacitors, and fuel cells. In particular he discusses hydrogen oxygen fuel cells. Mr. Johnson expresses in his article that 548 Watt-hours of energy may be obtained from a one liter tank of hydrogen at 3000 psi using a hydrogen-air fuel cell.

Similarly, Mr. Johnson claims that 12 Watt-hours of energy may be stored in a one liter tank of air compressed to 3000 psi. Mr. Johnson further states that a theoretical efficiency of the turbine may be as high as 40% which yields 5.75 Watt-hours of energy per liter of air compressed to 3000 psi. A marine battery which is a deep cycle battery will supply between 2000 Watt-hours and 4800 Watt-hours when used in conjunction with a powerverter aps unit such as that supplied by trip light power protection. Powerverter aps units automatically sense and switch AC output between an outside power source such as a utility and battery power when no AC power is available. The power supplied to the load will provide the energy at 120 VAC at a frequency of 60 cycles per second.

Compressed air under high pressure has been effectively demonstrated as a fuel to run automobiles. French Engineer Guy Negre has developed a compressed air driven automobile whose compressed air tank is recharged by a standard electrical outlet and compressor driven by an electric motor. Mr. Negre's concept, known as the Zero Pollution concept, can be viewed on the internet at http://www.zeropollution.com/zeropollution/body_concept.html.

Horizon Signal Technologies at http://www.horizonsignal.com/specs.htm cites Horizon's portable traffic system which utilizes a deep cycle battery to power a signal. Signalman, another portable traffic control system found on the internet at http://www.signalman.net/, discloses a battery powered signal device based on U.S. Pat. No. 5,001,475.

Traffic signals are the subject of an article entitled “Traffic Signals” found at http://members.home.net/traffic-signals/information/basic.htm. This article defines the equipment used in controlling vehicular traffic. The article cites the fact that North American traffic controller cabinets normally run on 120 VAC power. Traffic signals which are defined in the article as traffic signal heads are constructed of cast aluminum or plastic for low weight. The article further cites that the signal heads are illuminated by special traffic signal incandescent light bulbs having power requirements which range from 69 to 135 watts. The article further cites new LED (light emitting diode) signal heads which conserve power by using only 10 watts.

Many intersections now have signals which employ traffic signal heads which require 12 light bulbs to be lit at a time. Therefore, to be conservative approximately 2000 Watt-hours of energy are necessary to power a modern intersection.

U.S. Pat. No. 5,001,475 to Scovin discloses a portable traffic control device which includes an upright double sided human shaped figure which simulates a traffic control officer. The portable traffic control device is powered by two batteries.

U.S. Pat. No. 6,153,943 to Mistr, Jr. discloses a power conditioning apparatus with energy conversion and storage. The '943 patent discloses a gas storage reservoir in combination with a regulated fuel supply to supply electrical energy when economic conditions dictate. The '943 patent is an apparent outgrowth of the electrical energy deregulation programs which are currently sweeping the United States.

Ironically, it appears that electrical energy deregulation has contributed to a shortfall in the available electrical energy in California which is in fact making the problem of intersection traffic control a very bad one.

U.S. Pat. No. 6,204,572 B 1 to Liran discloses a power supply for providing instantaneous energy during an electrical utility outage. The '572 patent uses a flywheel to accommodate for transient conditions when utility power is lost but it also uses a backup supply generator for the continuous supply of electrical energy as needed.

### SUMMARY OF THE INVENTION

The instant invention is an emergency vehicular traffic control apparatus. The process for supplying emergency power to a traffic signal is disclosed herein. Emergency energy may be stored in a deep cycle battery, compressed air or in a hydrogen tank. The deep cycle battery is used in conjunction with a charger and inverter. Energy from the utility is supplied to the load, in this case the load is a traffic control station within a control box or cabinet. The energy from the battery, compressed air, and/or hydrogen tank is converted into usable alternating current at 120 VAC (60 Hz) which is then supplied to the control station. By control station is meant a traffic controller cabinet. The traffic controller cabinet is the large electrical control box which is usually located near one of the poles which support lights at an intersection. The traffic control cabinet usually contains many subsystems that process data and output signals to the traffic signal heads which control the vehicular traffic. Typically the subsystems include power supplies, field input terminals, lube protectors, fuses and the like.

In one embodiment the emergency vehicular traffic control apparatus includes a deep cycle battery, a charger to charge the battery, a relay for sensing the loss of power from the utility system, the relay including contacts for alternately delivering energy to and from the deep cycle battery, and an inverter for supplying alternating current to the traffic signal control box. The equipment may be mounted adjacent to the control box (also known as the control station or control cabinet) or it may be located remotely.

Another embodiment of the emergency vehicular traffic control apparatus includes a traffic control station, a fuel cell, a hydrogen supply, a solenoid valve interposed between the hydrogen supply and the fuel cell, the solenoid valve being opened upon the loss of power to the traffic control station, a relay for sensing the loss of power from the utility and an inverter for converting the DC power output from the fuel cell to alternating current power supplied to the traffic control station. The traffic control station then controls the traffic signal.

A third embodiment of the emergency traffic control apparatus comprises a control station having a logic package for controlling the traffic signal, a relay for sensing the loss of utility power being supplied to the control station, a motor driven air compressor powered from the utility when the utility power is present, a compressed air reservoir for storing the compressed air, a pressure switch interconnected with the reservoir for controlling the motor driven air compressor, and, an air powered turbine generator for generating alternating current power to be supplied to the control station without loss of the utility power to the control station. In this embodiment, namely, the compressed energy storage embodiment, the aforementioned equipment may be located within the traffic control signal supporting pole. This is the pole that supports the traffic lights also known as the signal heads.

All of the embodiments of the invention optionally include a

Accordingly, it is an object of the present invention to store energy for controlling traffic signal heads upon loss of electrical energy from the utility.

It is an object to store energy in a chemical form, namely, in a battery, to supply energy to a signal control cabinet and all the equipment therein upon the loss of utility power.

It is an object of the present invention to store energy in the form of compressed air. The compressed air is then used to drive a turbine generator to supply energy to the control station having a logic package for controlling the traffic signal.

It is an object of the present invention to store energy in a hydrogen tank for use in generating DC power from a fuel cell. The DC power from the fuel cell is generated when hydrogen is supplied to one side of the fuel cell upon the loss of electrical energy from the local utility. The DC power supplied by the fuel cell is applied to an inverter wherein alternating current is then supplied to the control station which controls the traffic signal heads.

Other objects of the invention will be understood when reference is made to the Brief Description of the Drawings, Description of the Invention, and claims which follow hereinbelow.

### BRIEF DESCRIPTION OF THE DRAWINGS

FIG. 1 is a schematic of a battery backup power supply to a control station which implements control signal logic.

FIG. 2 is a schematic of a compressed air energy storage system for supplying power to a control station which implements traffic control signal logic.

FIG. 3 is a schematic of a fuel cell energy storage system for supplying power to a control station which implements traffic control signal logic.

FIG. 4 is a perspective view of a typical traffic control cabinet which houses the control station which implements traffic control system logic.

FIG. 5 is a perspective view of a typical signal light pole supporting lights at an intersection with the traffic control cabinet in the background.

FIG. 6 is a cross-sectional view taken along the lines 6-6 of FIG. 5 illustrating a cabled wire bundle inside the traffic signal pole.

FIG. 7 is a cross-sectional view taken along the lines 7-7 of FIG. 5 schematically illustrating the motor driven air compressor, air reservoir and air driven turbine generator all mounted within the traffic signal pole.

A better understanding will be had when reference is made to the Description of the Invention and claims which follow hereinbelow.

### DESCRIPTION OF THE INVENTION

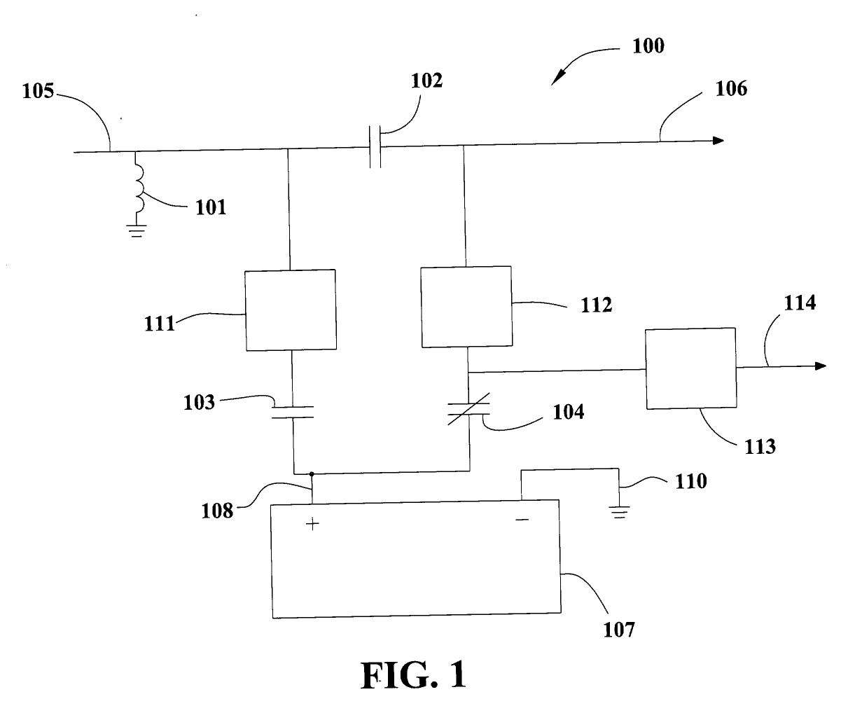

FIG. 1 is a schematic 100 of a battery 107 used in conjunction with a charger 111 an and inverter 112 to supply power to a traffic control logic system upon loss of utility generated power. Relay 101 senses the existence or nonexistence of power supplied by the utility as represented by reference numeral 105. Relay 101 may be a solid state relay. Power is supplied 105 by the utility subject to rolling blackouts which may occur in the absence of sufficient generating capacity. Power is normally supplied by the utility at 120 VAC and 60 Hz. Contacts 102 and 103 are normally open contacts of relay 101. Contact 104 is a normally closed contact of relay 101. By normally open it is meant that with relay 101 deenergized, contacts 102 and 103 are open and contact 104 is closed. Reference numeral 111 represents a charger which charges a deep cycle marine battery 107 when utility power is unavailable at the point indicated by reference numeral 105.

Reference numeral 108 simply indicates a cable supplying power to the positive or cathodic terminal of the battery. Reference numeral 110 schematically indicates a line connected to ground from the anode of the deep cycle marine battery. Reference numeral 112 is an inverter which takes the DC power output across the terminals of the deep cycle marine battery 107 and runs it through a normally closed contact 104 and into inverter 112 which inverts the power from a direct current power to an alternating current power. Alternating current is then supplied to the load 106 as indicated in FIG. 1.

Transmitter 113 senses the presence of power being supplied by the emergency energy power source. Transmitter 113 transmits a radio signal frequency signal to a police station, an emergency operations center or a police car equipped with a receiving unit. Alternatively, transmitter 113 may send a signal over a wire to a police station or emergency operations center. Arrow 114 indicates the signal transmission to a police station or other governmental entity indicating that power is being supplied by the emergency energy source. This signal to the police or others will alert them to the fact of the power outage enabling them to utilize their resources in the most effective way.

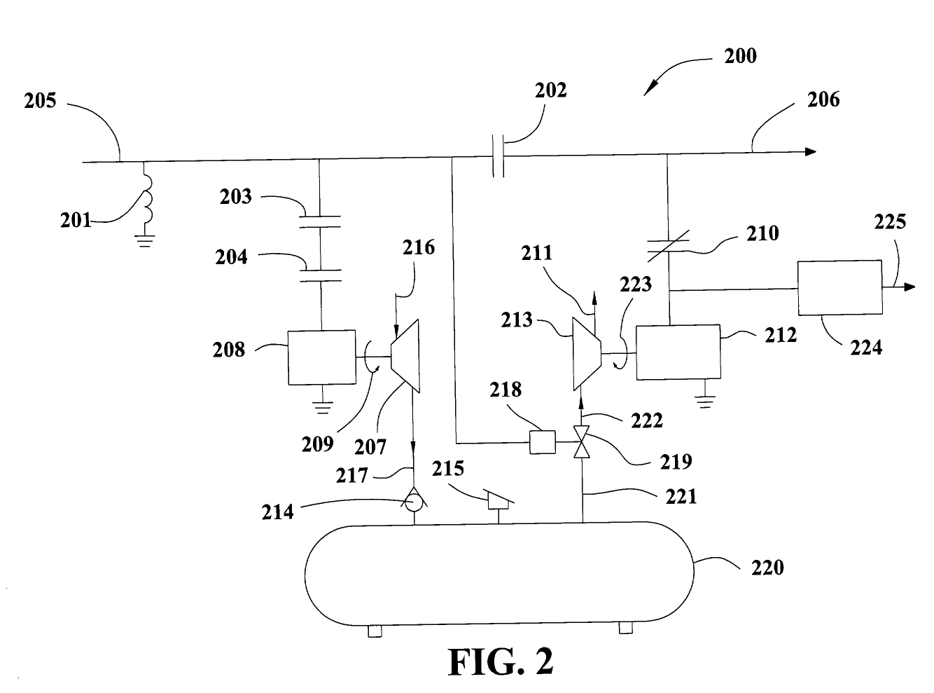

FIG. 2 is a schematic 200 of a compressed air energy storage system for supplying alternating current power to a control station which implements traffic signal logic. Utility power is normally present at reference numeral 205 and sensing relay 201 monitors the presence or absence of electric utility power. Relay contacts 203, 202 and 210 are associated with sensing relay 201. Relay contacts 203 and 202 are normally open contacts and relay contact 210 is a normally closed contact. By normally open it is meant that when relay 201 is deenergized contacts 203 and 202 are opened and contact 210 which is normally closed is closed in the absence of power across relay 201.

Pressure switch 215 is interconnected with air reservoir 220. The contact 204 is associated with pressure switch 215 and opens upon the achievement of the pressure set point within the reservoir 220. When the pressure is below the desired set point within tank 220, contact 204 is closed. When electrical power of sufficient voltage and current is available at power supply 205, then contacts 203 and 202 associated with relay 201 are closed. As used herein when it is stated that a contact is associated with a relay or pressure switch it is meant that it is driven by the relay or switch and is integral therewith. In this case the load 206 is a traffic signal control cabinet containing equipment which selectively directs power to the traffic control signal heads. Further, in this condition, the motor 208 may be operated to drive air compressor 207 if the pressure in the reservoir 220 is below the set point of pressure switch 215. Reference numeral 209 merely signifies the rotation of a shaft which couples the electrically driven motor 208 to the compressor 207. Reference numeral 216 represents an air supply intake to the compressor and reference numeral 217 indicates an air supply line to the reservoir. Reference numeral 214 is a check valve which is interposed between the compressor 207 and the air storage tank 220 to prevent reverse rotation of the compressor 207 and motor 208.

Solenoid valve 219 is interposed between the reservoir 220 and the air driven turbine 213. Solenoid 218 which controls the valve 219 associated therewith is powered when electrical voltage and current of sufficient magnitude is available at point 205 as is indicated in FIG. 2. When electrical energy of sufficient magnitude is present at 205 the solenoid valve 219 is closed.

Air line 221 interconnects the storage tank 220 and solenoid valve 219. Air line 222 interconnects the solenoid valve 219 and turbine 213. Transmitter 224 senses the presence of power being supplied by the emergency energy power source. Arrow 225 indicates the signal transmission to a police station or other governmental entity indicating that power is being supplied by the emergency energy source. This signal to the police or others will alert them to the fact of the power outage enabling them to utilize their resources in the most effective way.

Reference numeral 211 signifies the exhaust of the air driven turbine 213. Reference numeral 223 indicates rotation of a shaft which couples the air driven turbine 213 and a generator 212. Generator 212 is coupled to the output load 206 when the relay 201 is deenergized. This occurs through normally closed contact 210 as explained previously. Reference may be made to FIG. 7 at this time.

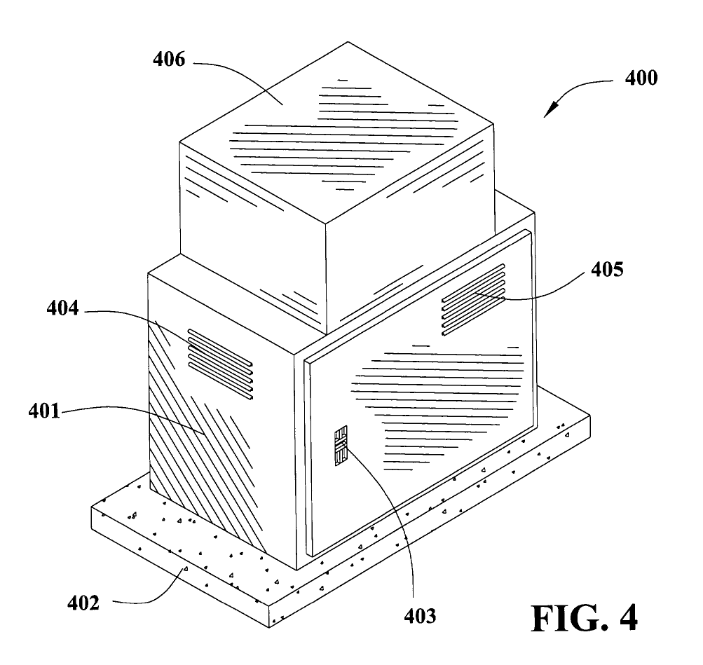

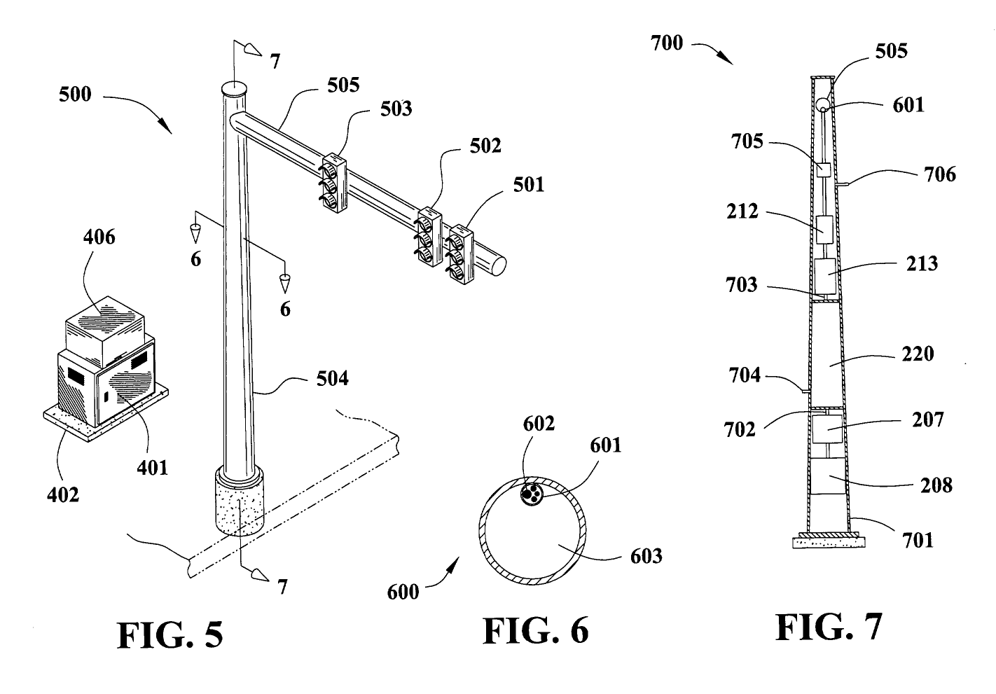

Referring to FIG. 7 which is a cross-sectional view 700 taken along the line 7-7 of FIG. 5 illustrating schematically the motor driven air compressor 207, the air reservoir 220 and its air driven turbine generator 213/212 all mounted within a traffic signal pole 504. Traffic signal pole 504 may be best viewed in FIG. 5. Most modern cities have done away or are in the process of doing away with traffic signals heads which are supported by wires or metal lines. The new traffic signal poles are much more esthetically pleasing than were the supporting lines. Referring still to FIG. 7 air reservoir 220 is sized to provide enough energy to meet the energy requirement. The more energy required to run the lights during utility power outages, the larger volume 220 needs to be. Reference numeral 704 is a quick disconnect coupling. If a city or municipality desires they may be able to charge the volume 220 from a portable air compressor which may be hauled around behind a pickup truck for instance. In this event the motor 208 and compressor 207 are not necessary because the energy is stored in reservoir 220 by virtue of the mobile air compressor. The municipality crew merely drives around periodically and supplies the air reservoirs 220 with sufficient pressure to operate the turbine motor packages 213/212. This as the advantage of eliminating the motor 208 and compressor 207 from each location. Reference numeral 706 is a vent which is necessary to vent air from the exhaust of the turbine 213. The vent may also occur naturally through conduit 505 which supports the lights. Conduit 505 necessarily has openings behind signal heads 501, 502 and 503 as shown in FIG. 5. These openings are necessary for wiring which drives the signals. Conduit 702 and 703 are air passageways. Junction box 705 works in conjunction with control station 401 which will be discussed hereinbelow. Air supply opening 701 is viewed in FIG. 7 and this is an opening in the pole to allow air to be brought therein for compression by compressor 207.

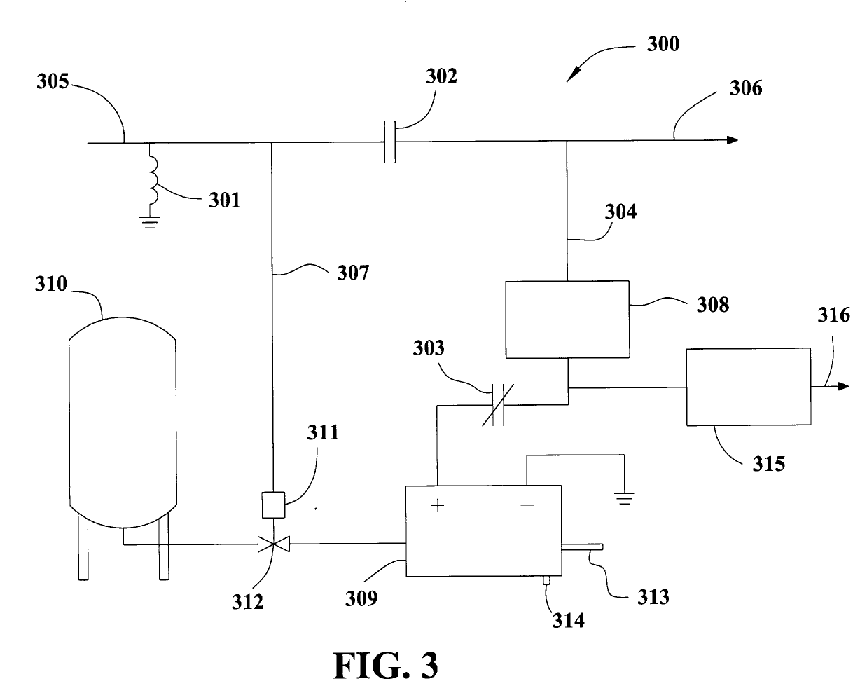

Referring to FIG. 5, a perspective view 500 of a typical signal light pole 504 supporting signal lights or signal heads as they are known at an intersection with the traffic control cabinet 401 in the background. Traffic control cabinet 401 is illustrated best in FIG. 4 and includes PLC or other logic control devices for operating the signals heads 501, 502 and 503. Typically the traffic control cabinet is supported on a cement pad 402. The traffic control cabinet includes vents 404, 405 as best viewed in FIG. 4. FIG. 4 is a perspective view 400 of a typical traffic control cabinet which houses the control station which implements the traffic control system logic. Access is gained to the traffic control cabinet through handle 403. The energy sources and equipment disclosed herein may be mounted in a box on the top of the traffic control cabinet. The battery backup, and fuel cell embodiments of this invention illustrated in FIGS. 1 and 3 are particularly apt to be mounted on top of the traffic control cabinet 401. Reference numeral 406 is the box or cabinet which houses the equipment set forth in FIGS. 1-4. The size of the box is dictated by the size of the equipment used such as the battery, hydrogen tank or compressed air storage tank. Interconnections between the box 406 and the control cabinet 401 which contains the signal controls can be easily made by cutting through the top of control cabinet 401.

Referring again to FIG. 5 the perspective view 500 of traffic signal light pole, a typically large diameter metal pole 504 is used. The light pole cross bar which supports the lights is indicated in FIG. 5 by reference numeral 505.

FIG. 6 is a cross-sectional view 600 taken along the lines 6-6 of FIG. 5 illustrating a wire bundle 602 residing within a cable 601. Cable 601 is a metal conduit or plastic conduit which is preferably sealed. Reference numeral 603 indicates the available space for the storage of air if so desired. If it is desired to store the air within the pole 504, it is stored in a way similar to that shown in FIG. 7. Necessarily in FIG. 7 a check valve or other device will be used between the compressor 207 and the storage tank 220. The check valve would be in air conduit 702.

Referring to FIG. 3, a schematic 300 of a fuel cell 309 energy storage system for supplying power to a control station which implements traffic signal control logic. The control station is located in the control cabinet. Sensing relay 301 which monitors the existence or nonexistence of power supplied from the utility. The power supplied from the utility is typically 120 VAC, 60 hertz. Relay contact 302 is a normally opened contact and relay contact is a normally closed contact. In other words, when power exists at 305, contact 302 of relay 301 is closed and contact 303 of relay 301 is opened. Hydrogen tank 310 is filled with compressed hydrogen which is supplied to the fuel cell upon the discontinuance of power at 305.

Valve 312 is open when power is not present at 305. Air supply 313 is fed into fuel cell 309. Water is drained 314 from the fuel cell when power is being output at the positive or cathodic terminal of the fuel cell through closed relay contacts 303 to inverter 308 which converts the DC power to AC power which is output on line 304. Power output in the form of alternating current is supplied to the traffic signal control device 306 (sometimes referred to herein as the control station 306). Line 307 merely indicates the electrical connection between the power supply line and the solenoid 311. When solenoid 311 is energized valve 312 is closed. When solenoid 311 is deenergized valve 312 is open and this allows the passage of hydrogen to the fuel cell. Two thousand 2000 Watt-hours of energy can easily be supplied from a mere four (4) liters of hydrogen at 3000 psi. Obviously a larger volume and lower pressure may be used to supply the fuel cell. The physical constraints of the size of box 406 are the limiting factors in the size of tank 310.

Transmitter 315 senses the presence of power being supplied by the emergency energy power source. Arrow 316 indicates the signal transmission to a police station or other governmental entity indicating that power is being supplied by the emergency energy source. This signal to the police or others will alert them to the fact of the power outage enabling them to utilize their resources in the most effective way.

Those skilled in the art will readily recognize that modifications and changes may be made to the invention as disclosed herein without departing from the spirit and scope of the appended claims.

We claim:

1. An emergency automobile traffic control apparatus comprising a deep cycle battery, a charger to charge said battery, a relay for sensing power loss, said relay includes contacts for alternately delivering energy to and from said deep cycle battery, an inverter for supplying alternating current, and, a traffic control station for driving a traffic light for controlling automobile traffic.

2. An emergency automobile traffic control apparatus as claimed in claim 1 wherein said traffic light employs incandescent lights.

3. An emergency automobile traffic control apparatus as claimed in claim 1 wherein said traffic light employs light emitting diodes.

4. An emergency automobile traffic control apparatus as claimed in claim 2 wherein said deep cycle battery is a marine battery.

5. An emergency automobile traffic control apparatus as claimed in claim 4 further comprising a control station for controlling said traffic signal and wherein said battery, said charger, said relay, and said inverter are mounted adjacent to said control station for provision of AC power to said control station.

6. An emergency automobile traffic control apparatus comprising a traffic control station, a fuel cell, a hydrogen supply, a solenoid valve interposed between said hydrogen supply and said fuel cell, said solenoid valve opening upon the loss of power to said traffic control station, a relay for sensing loss of utility generated power, an inverter for converting DC power output from said fuel cell to AC power output to said traffic control station, and, said traffic control station controlling a traffic signal.

7. An emergency automobile traffic control apparatus as claimed in claim 6 further comprising a pole for supporting said traffic signal.

8. An emergency automobile traffic control apparatus as claimed in claim 7 wherein said hydrogen supply, said fuel cell, said solenoid valve and said inverter are mounted adjacent to said control station for provision of AC power to said control station.

9. An emergency automobile traffic control apparatus as claimed in claim 7 wherein said hydrogen supply, said fuel cell, said solenoid valve and said inverter are mounted within said pole.

10. An emergency traffic control apparatus comprising a traffic light; a control station having traffic control logic for controlling said traffic signal; a relay for detecting loss of utility power to said control station; an air compressor-motor package powered from said utility power; a compressed air reservoir; a pressure switch interconnected with said reservoir; an air powered turbine generator; and, said air powered turbine generator supplying AC power to said control station upon loss of utility power to said control station.

11. An emergency traffic control apparatus as claimed in claim 10 further comprising a pole for supporting said traffic signal; and, wherein said compressed air reservoir, said air compressor-motor package, and said turbine generator are located within said pole.

12. An emergency traffic control apparatus as claimed in claim 10 wherein said compressed air reservoir, said air-compressor-motor package, and, said turbine generator are located adjacent said control station.

13. A process for supplying emergency power to a traffic signal normally driven from utility generated power utilizing a deep cycle battery, a charger, a relay for sensing loss of utility power, an inverter, a control station for implementing traffic signal control logic comprising the steps of: sensing loss of utility power with said relay; opening a contact of said relay disconnecting said utility power from said control station; supplying DC power from said deep cycle battery to said inverter; inverting said DC power into AC power; supplying AC power to said control station; and, opening a contact of said relay so as to disconnect said charger from said control station.

14. A process for supplying emergency power to a traffic signal normally driven from utility generated power utilizing a relay, a motor driven air compressor, a compressed air storage reservoir, an air turbine generator, and a control station for implementing traffic signal control logic comprising the steps of: isolating utility power from said control station with said relay and said contacts of said relay; compressing air with said motor driven air compressor; storing said compressed air in said reservoir; driving said air driven turbine generator upon loss of utility power; and, supplying AC power to said control system.

15. A process as claimed in claim 14 wherein said air reservoir, said motor driven compressor and said air driven turbine generator are located within a pole supporting said traffic signal.

16. A process for supplying emergency power to a traffic signal normally driven from utility generated power utilizing a relay, an air supply reservoir having a quick disconnect coupling; an air-driven turbine generator; and a control station for implementing traffic signal control logic comprising the steps of: charging said air supply reservoir with an external compressor; sensing the loss of utility power with said relay; disconnecting, through use of a relay contact, said utility power form said control station; and, generating AC power form said air driven turbine generator and supply said AC power to said control station for implementing traffic control signal logic.

17. A process for supplying emergency power to a traffic signal normally driven from utility generated power utilizing a relay, a hydrogen source, a solenoid valve, a fuel cell, a control station for implementing signal control logic, and an inverter comprising the steps of: sensing loss of utility power with said relay; disconnecting said utility power from said control station; opening said solenoid valve enabling hydrogen to be communicated between said hydrogen source and said fuel cell; generating DC power with said fuel cell; and, inverting said DC power to AC power and supplying said AC power to said control station for controlling said traffic signal.

18. An emergency automobile traffic control apparatus as claimed in claim 1 further comprising a transmitter of sending a signal to a remote location indication that emergency power is being supplied to said control station.

19. An emergency automobile traffic control apparatus as claimed in claim 6 further comprising a transmitter of sending a signal to a remote location indication that emergency power is being supplied to said control station.

20. An emergency traffic control apparatus as claimed in claim 10 further comprising a transmitter of sending a signal to a remote location indication that emergency power is being supplied to said control station.
